(19) United States
(12) Patent Application Publication
(10) Pub. No.: US 2020/0184991 A1
(43) Pub. Date: Jun. 11, 2020

(54) SOUND CLASS IDENTIFICATION USING A NEURAL NETWORK

(71) Applicant: PASCAL CLEVE, SUDBURY, MA (US)

(72) Inventor: PASCAL CLEVE, SUDBURY, MA (US)

(21) Appl. No.: 16/210,431

(22) Filed: Dec. 5, 2018

(51) Int. Cl. G10L 25/30; G10L 25/57; G10L 25/60; G06N 3/08; H04S 7/00; H04N 7/15

(52) U.S. Cl. CPC G10L 25/30; G10L 25/57; H04N 7/155; G06N 3/08; H04S 7/40; G10L 25/60

(57) ABSTRACT

An audio or video conference system operates to receive sound information, sample the sound information and transform each sample of sound information into a sound image representing one or more sound characteristics. Each sound image is applied to the input of a neural network that is trained, using training sound images, to identify different classes of sound, and the output of the neural network is the identity of a class of sound associated with the sound image applied to the neural network. The identity of the sound class can be used to determine how the sample of sound is processed prior to sending it to a remote communication system.

### 1. FIELD OF THE INVENTION

The present disclosure relates to a conference system that uses a trained neural network to identify different classes of sound energy.

### 2. BACKGROUND

Meetings conducted in two separate locations with at least one of the locations involving two or more individuals can be facilitated using an audio or video conference system, both of which are referred to herein as a conference system. Audio conference systems typically include some number of microphones, at least one loudspeaker, and functionality that operates to convert audio signals into a format that is useable by the system. Video conference systems can include all the functionality associated with an audio conference system, plus they can include cameras, displays and functionality for converting video signals into information usable by the system.

Among other things, a conference system operates to receive sound information (speech, echo, noise, etc.) from the environment in which it operates, and to process the sound information in a number of ways before sending them to a remote communication device to be played. Generally, conference systems are designed to capture as much of the direct sound energy generated by speakers in the near-field with respect to the system and to filter out as much of the other sound energy (i.e., echo, reverberation, far-field sound and ambient noise) as possible. In this regard, a conference system can be configured with functionality that operates to improve the quality of an audio signal transmitted to a remote system in a number of different ways, such as amplifying and/or attenuating a portion or all of the audio signal, controlling a microphone gating operation, suppressing environmental noise or unwanted, far-field speech information, removing reverberant energy and/or removing acoustic echo present in a microphone signal.

Different signal processing techniques can be applied to different types or classes of sound to improve the quality of an audio signal (i.e., microphone signal), and sound can be classified as acoustic echo, reverberant sound, far-field or near-field voice, noise (i.e., relatively high-level environmental sound) or silence (i.e., relatively low-level environmental sound). A conference system can be configured to use different or some combination of signal processing techniques to process each class of sound. For example, acoustic echo can be mitigated by applying acoustic echo cancellation to a microphone signal. Reverberant sound can be removed by applying any one of a number of different techniques such as dereverberation or by attenuating certain lower audio signal frequencies. Noise can be mitigated by attenuating an audio signal prior to being sent to a remote system, and far-field sound can be removed from an audio signal by gating (turning off) a microphone.

Environmental factors can contribute to the quality of a microphone signal. These factors can include, among other things, the acoustics of an environment in which the conference system is operating, the positioning of the microphones with respect to conference system users and the distance between the microphones and the users, the size of the room, and how much acoustic energy received by the microphone is direct energy and how much is reflected energy.

### 3. BRIEF DESCRIPTION OF THE DRAWINGS

The present invention can be best understood by reading the specification with reference to the following figures, in which:

FIG. 1 is a diagram showing a room in which a conference system is operating.

FIG. 2 shows an audio conference system 110 having microphone signal processing functionality based upon the system identifying different classes of sound.

FIG. 3 is a timeline illustrating how sample of sound information can be captured.

FIG. 4 is a diagram showing a structure in which sound images corresponding to different classes of sound can be stored for training a neural network comprising the conference system.

FIG. 5 is a diagram showing a design for the neural network comprising the conference system.

FIGS. 6A-6E are sound images each corresponding to five different classes of sound.

FIG. 7A is a diagram showing functionality comprising the microphone signal processing 180.

FIG. 7B is a diagram showing instructions used to control a frequency equalization function.

FIGS. 8A and 8B is a logical flow diagram of a microphone signal processing methodology.

### 4. DETAILED DESCRIPTION

While AEC functionality can operate in a conference system to improve the quality of a microphone signal by removing much of the acoustic echo, it can be difficult or not possible to control some environmental and human factors that can contribute to poor microphone signal quality. For example, it may not be possible to control the size of a conference room in which a conference system operates. Also, while it is possible to improve the acoustical characteristics of the room, the acoustics of the room may change as more or fewer individuals participate in a conference session, or when the participants or furniture move around during a conference call. Further, the positions of microphones and the distances between the microphones and participants can change or not be optimal which can have an affect on the quality of an audio signal sent to a remote communication device. Given these environmental limitations and participant dynamics, it can be a difficult task to capture and process a microphone signal such that the audio sent to a far-end system is of the highest possible quality.

I have discovered that sound information captured by a microphone and transformed into sound image information can be used to train a conference system to identify different classes or types of sound (i.e., near-field voice, far-field voice, noise, silence) received by the system, and that each class of sound that is identified in an audio signal can be a determining factor in how the audio signal is processed by the conference system.

Specifically, a plurality of training recordings of each class or type of sound can be transformed into training sound images (i.e., spectrograms or Mel Frequency Cepstrum Coefficients or MFCC) that are visual representations of one or more characteristics of at least some portion of the sound recordings. These sound characteristics can be, but are not limited to, frequency or frequency range, amplitude/power, and time. Then, a neural network that is separate from or integral to the conference system can be trained to recognize each of the sound classes by applying the training sound images to an input of the neural network. Once the neural network is trained, sound received by the system during a conference call can be identified according to a sound class, and each class of sound can be processed by the system using an appropriate signal processing technique to improve the quality of an audio signal as perceived by an individual participating in a call at a far-end communication system.

According to one embodiment, the neural network can be trained to identify near-field sound corresponding to speech received from a sound source (i.e., person). Near-field sound is defined here to mean any sound arriving at the system from a source that is within some specified distance, which is typically an effective range of a system microphone, for example. Further, the neural network can be trained to identify sound that arrives at the system from different distances within the near-field (i.e., sound that arrives at the system from a distance of two feet or 4 feet, or sound that arrives at the system from a source that is greater than zero feet but less than two feet from the system, or sound that arrives at the system from a distance of greater than two feet but less than four feet). This type of speech related sound is referred to here as a first class or type of sound, and depending upon the distance from the system to the sound source, different signal processing techniques can be applied to the sound. In this regard, more or less frequency equalization can be applied to certain frequency bands comprising sound captured by the system depending upon the distance from the sound source to the conference system.

According to another embodiment, the neural network can be trained to recognize sound that arrives at the system from a source that is beyond a specified, maximum distance (i.e., effective range of a microphone) and remove this sound from a signal prior to it being transmitted to a far-end system by gating system microphones. This specified, maximum distance is referred to here as an infinite distance.

According to another embodiment, the neural network can be trained to recognize noise that arrives at the system and remove this noise (i.e., relatively high levels of environmental sound) from the signal prior to it being transmitted by attenuating the noise or by gating the microphones.

According to yet another embodiment, the system can be trained to recognize relatively low levels of environmental noise (silence) and remove this noise from the signal as needed by attenuating the low-level noise or by gating the system microphones.

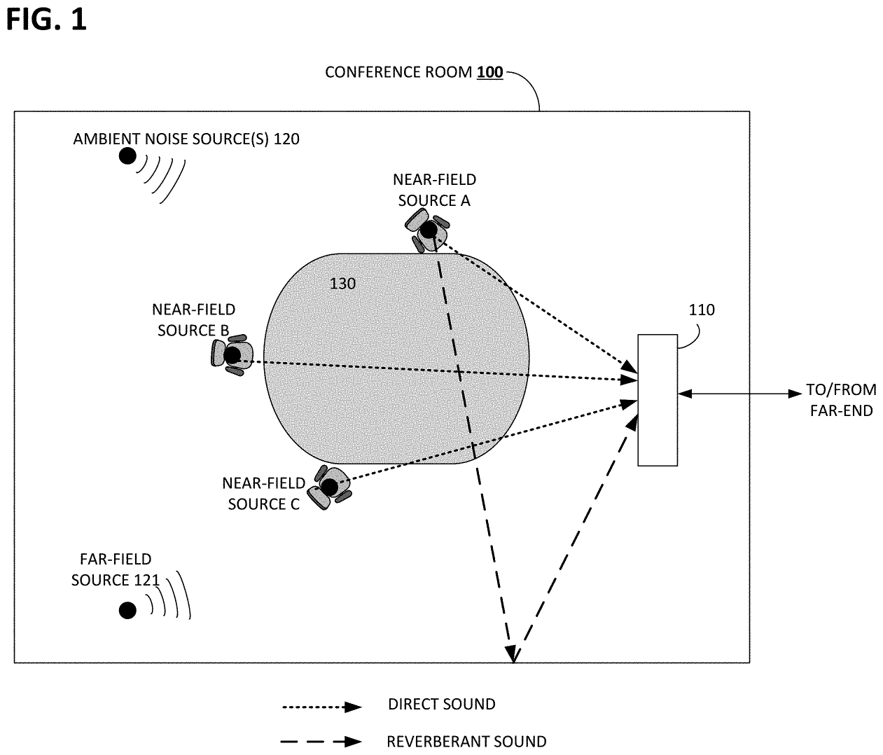

These and other embodiments will now be described with reference to the figures, in which FIG. 1 is a diagram showing a conference room 100 having a conference system 110 connected over a communication network (not shown) to a remote communication system, some number of conference call participants or system users labeled near-field sources A, B, and C that are positioned around a conference table 130 that is proximate to the conference system, and ambient noise and far-field sound sources 120 and 121 respectively. The conference system 110 generally operates to receive sound generated by near-end (local) sources in the conference room (or located proximate to the room . . . i.e., proximate to a conference room door opening), process the sound received in a variety of ways before transmitting the sound as an audio signal to a far-end (remote) communication device. The near-field sound sources, which in this case are system users, are shown positioned around the conference table at different distances from the conference system, and each of the sources, Source A, Source B and Source C generate sound (a speech signal in this case) that travels directly to the conference system and sound that arrives at the systems after reflecting off one or more wall of the conference room. Near-field sound energy according to this description refers to sound that is generated within an effective operational range of microphones (not shown) comprising the conference system 110, and the effective operation range (and so the area associated with the near-field) of the microphones can vary depending upon the microphone specifications. Sound energy that does not travel to the system directly is referred to here as reflected or reverberant sound.

Continuing to refer to FIG. 1, the source 121 of far-field sound energy can be a person in the conference room 100 (or proximate to the room) who is speaking but who is not currently participating in a conference call, and the ambient noise generated by the source 120 can be any non-speech sound generated in or proximate to the conference room that is captured by the conference system. This noise can be generated in the near or far-field by any type of equipment running in or proximate to the room or generated by people who are participating or not participating in a conference call.

As described previously, a conference system is designed to process sound energy received from an environment in which it operates in order to improve the quality of an audio signal sent to a remote device to be played. In this regard, conference systems typically have functionality that operates to identify unwanted sound energy in order to remove as much of this energy as possible from an audio signal. In this regard, adaptive filters can be employed to remove acoustic echo, direction of arrival functionality can be used to drive microphone beam forming (spatial filtering), voice activity detection can control microphone gating or audio signal attenuation, certain sound energy characteristics can be detected and used to control functionality that operates to remove reverberation, and other techniques can be applied to microphone signals to improve audio signal quality prior to sending the signal to a remote device. The ability of a conference system to accurately identify different types of unwanted sound energy is critical to selecting the functionality that operates to most effectively remove this unwanted energy from the audio signal.

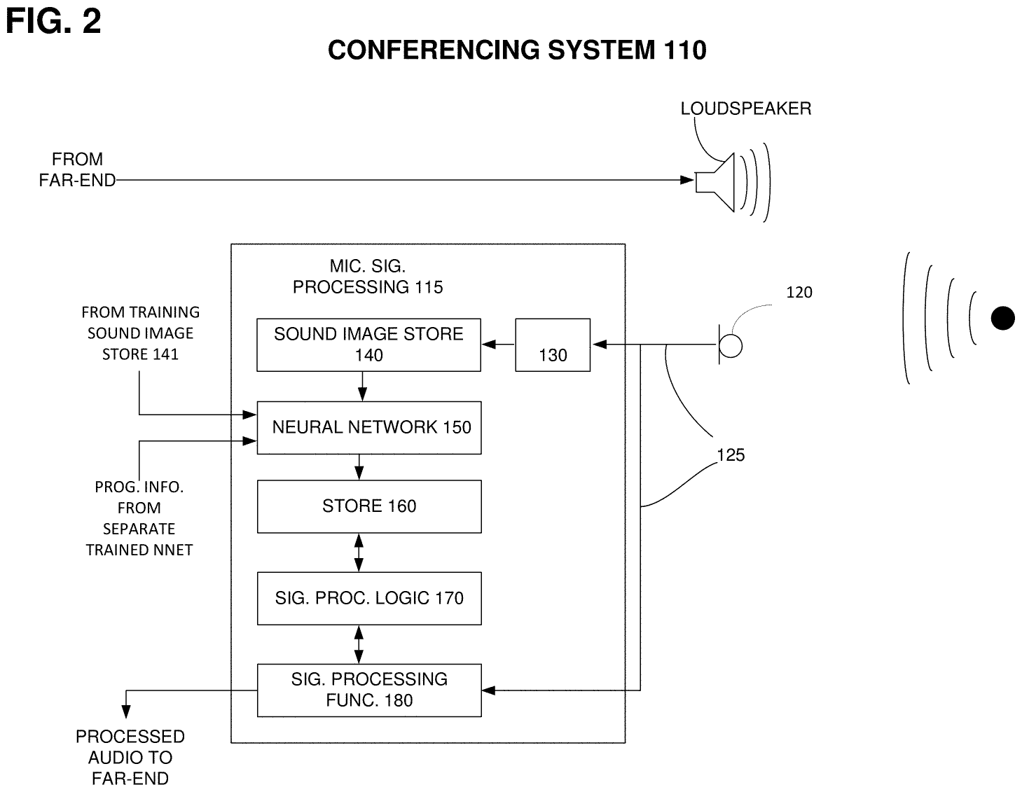

Referring now to FIG. 2, this figure shows functionality comprising the audio conference system 110 of FIG. 1 that operates to process a microphone signal prior to it being transmitted to a remote/far-end device. The system can be placed into a first mode of operation for the purpose of either programming or training a neural network comprising the system, and it can be placed into a second mode for normal operation during a conference call. It should be understood that while the conference system 110 in FIG. 2 only shows audio conference system functionality, the methodology described herein for using training images to identify different types of sound for the purpose of processing a microphone signal is not limited to use with an audio conference system, but can just as easily be applied to a video conference system as well.

The system 110 in FIG. 2 is comprised of a loudspeaker for playing audio received over a network from a remote device (such as a far-end conference system), several microphones 120 that operate to capture sound from the environment in which the system 110 operates, and microphone signal processing module 115. The processing module 115 is comprised of functionality 130 that operates to decompose or transform an audio signal 125 received from the microphones into a sound image that is a visual representation of one or more microphone signal sound characteristics such as frequency or frequency range, amplitude/power, and time. This sound image can be a spectrogram that represents one or more characteristics of the audio signal, or coefficients that comprise a short-term power spectrum of a sound such as Mel-frequency cepstral coefficients (MFCCs), and the resultant sound images are maintained in a store 140. The neural network 150 that once trained operates to identify different types or classes of environmental sound, a store 160 for at least temporarily maintaining information corresponding to a current type of sound identified by the neural network, and logic 170 that operates to control signal processing functionality 180 based upon the current identified type of sound.

With continued reference to FIG. 2, when the system 110 is operating in the first mode (training mode), pre-recorded training sound that has been previously transformed into images of sound information can be used to either train a neural network that is running in a computational device that is separate from the system 110, or (depending upon the compute capability of the system 110) train the neural network 150 that is integral to the system 110. In the former case, training images maintained in a store are applied to the input of a neural network (not shown) that is running on a compute device that is separate from the system 110 until it can be validated that the neural network can operate to accurately identify different types of sound. Subsequently, information comprising the trained neural network can be used to program the neural network 150 comprising the system 110. In the latter case, the neural network 150 can be trained by applying training images from a store 141 (not shown) to the input of the neural network 150 which then are used by the system to train the neural network 150. The ability of the neural network 150 to accurately identify different types of sound can be validated by means that are well known, and the training mode can be stopped at a point that the network is validated to provide sufficient accuracy. Different types of recorded sound can be used to train the neural network. Sound that is recorded for the purpose of training a conference system can be agnostic with respect to the environment in which a conference system operates. In this regard, the size and the acoustical properties of the room in which the training sound is recorded or in which the system may be operating may not be considered when recording the test sound. It can be important, however, that different types of sounds used for training are recorded in different environments and at difference distances from a source. Also, is can be important to record environmental noise of different types in different rooms. The training sound can be recorded by a sound recording device not associated with the conference system or it can be recorded by the conference system provided the system is configured with sound recording capability able to record sound at the appropriate sample rate.

For the purpose of this description, sound information captured by a microphone and transformed by a Fourier function into an image is referred to herein as a spectrogram, but it should be understood that sound information in a microphone signal can be transformed into other sound images such as a Mel Frequency Cepstrum Coefficient or any other type of image that represents sound information captured by a microphone.

Referring again to FIG. 2, when the system 110 is placed into the second or normal mode of operation, the microphones operate to capture sound during a conference call which is converted into a plurality of spectrograms by the Fourier transform functionality and maintained at least temporarily in the spectrogram store. When the system 110 detects that spectrogram information is present in the store, it applies an image of each stored spectrogram to the input of the trained neural network. Each succeeding spectrogram in the store is applied to the input of the trained neural network until such time that the system 110 is no longer operating to capture sound (i.e., the conference call is terminated).

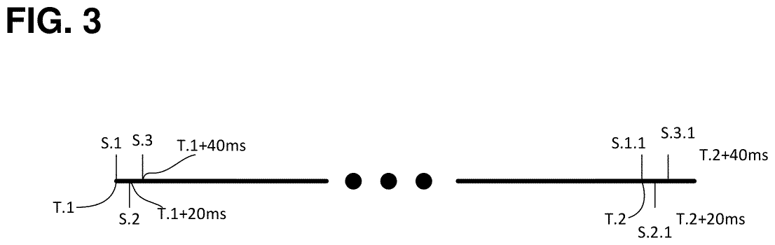

FIG. 3 is a time-line showing how samples of training sound can be recorded for later use during the training mode of operation. Each sample of training sound comprises one second of sound information that is recorded at regular twenty millisecond intervals at a bandwidth of 8 kHz, although the recording bandwidth can be greater or smaller. The recording process was performed by sliding a one second recording window forward in twenty millisecond increments for some period of time until a sufficient number of samples have been recorded. The number of sound samples needed to train the neural network is dictated by how much data is needed to train the network so that it can accurately identify different types of sound. At time T.1 in FIG. 3, a recording of a first sample (S.1) of training sound information is started and one second later at T.2 the recording of sound information for the first sample of training sound ends. Then, twenty milliseconds after T.1, a recording of a second sample of training sound information is started, and this sample ends one second later at T.2 plus twenty milliseconds. Then, forty milliseconds after T.1 a recording of a third sample of training sound information is started, and the recording for this sample ends one second later at T.2 plus forty milliseconds. This process continues until enough samples of training sound are stored to begin the neural network training process.

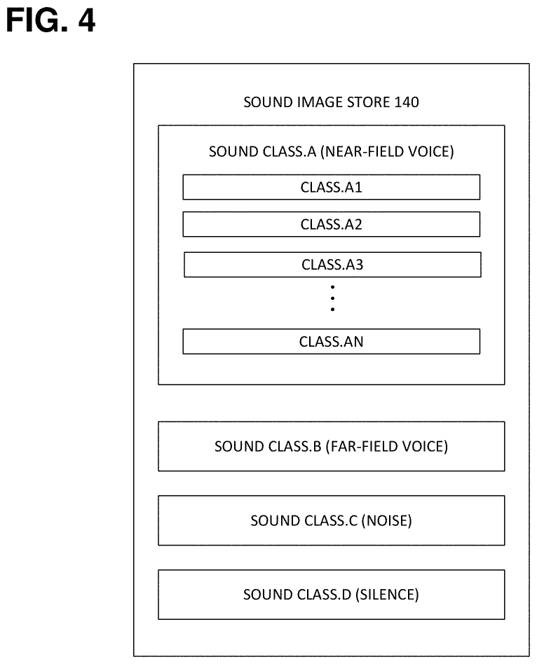

As previously described, the neural network 150 can be trained to identify a plurality of different classes of sound. In this regard FIG. 4 shows a number of spectrogram types that are maintained in the store 140 which can be used to train the neural network 150. According to one embodiment, the neural network is trained to identify four types or classes of sound, namely a Class.A, Class.B, Class.C and Class.D. Each class of sound can be divided into sub-classes, and in this regard Class.A is divided into a number of sub-classes labeled Class.A1, Class.A2, Class.A3 to Class.AN, with N being an integer number. Each sub-class of sound in Class.A represents sound information corresponding to speech received by the system 110 from a source located at different distances from the system 110. In this case, Class.A1 corresponds to speech information received from a source at a distance that is greater than or equal to two feet but less than four feet from the system 110, Class.A2 corresponds to speech information received from a source in a range that is greater than or equal to four feet but less than six feet, Class.A3 corresponds to speech information received by the system from a source that is greater than or equal to six feet but less than or equal to eight feet from the system. The neural network can be trained to identify more or fewer classes of sound, and so is not limited only to those shown and described with reference to FIG. 4.

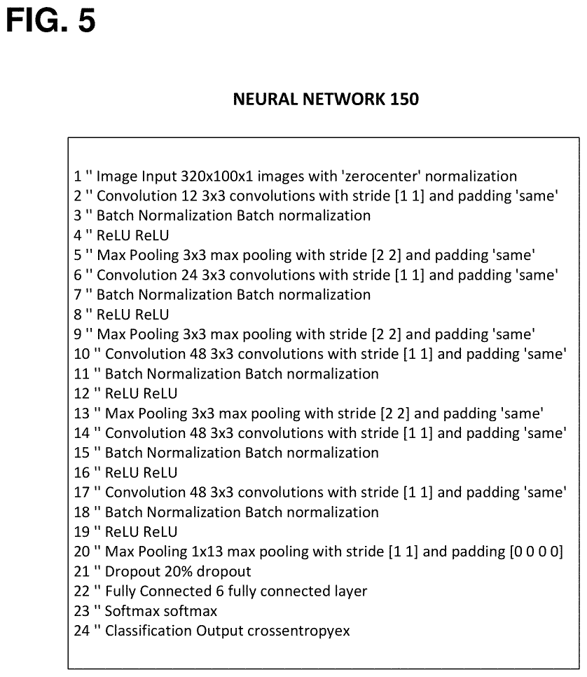

FIG. 5 illustrates a neural network design that can be used to implement the neural network 150 described with reference to FIG. 2. In this case the neural network is a convolutional neural network, which is a type that is typically used to identify different types of images, such as spectrogram images corresponding to different classes of sound. The neural network 150 in FIG. 5 is implemented in twenty-four layers, with each layer representing functionality that operates, in this case, on spectrogram image information. It should be understood, that a neural network implemented in the conferencing system of FIG. 2 is not limited to having twenty-four layers, but it could have more or fewer layers as well.

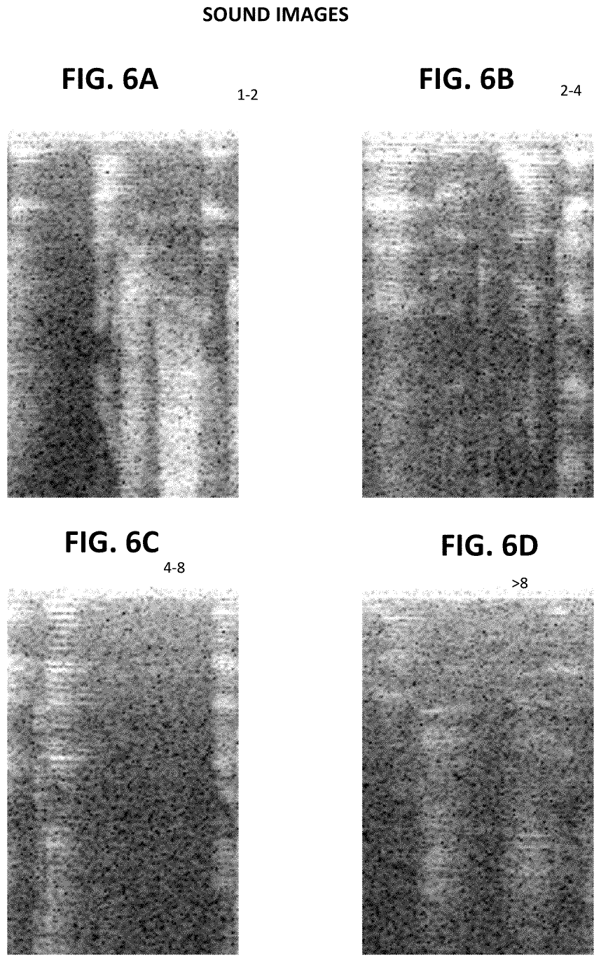

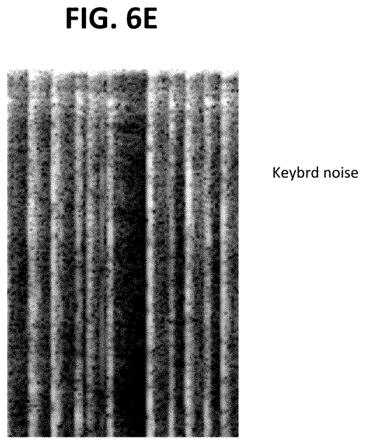

FIGS. 6A to 6E are images of five spectrograms that can be used to train the neural network 150 described with reference to FIG. 2. Each spectrogram represents one second of sound information captured by the microphone 120 with a resolution of 10 milliseconds. As described earlier, the number of spectrograms (i.e., the duration of training sound) applied to the neural network during the training mode of operation can be derived empirically or by validating the ability of the neural network to accurately identify different types of sound using well known validation tools . . . //there is some science behind that!//, //this previous part is not right. During training, I do not want to make any assumptions on the room//. For each spectrogram image, the horizontal axis represents time and the vertical axis represents frequency, with the top of the spectrogram image corresponding to lower frequencies and the bottom corresponding to higher frequencies. The grey scale color in the spectrograms corresponds to sound energy intensity or strength, with the lighter shades corresponding to relatively high energy and the darker shades corresponding to relatively lower energy. The spectrogram in FIG. 6A represents voice sound energy received at the system microphone(s) from a source that is one to two meters distant from the system, the spectrogram in FIG. 6B represents voice sound energy received from a distance of two to four meters, the spectrogram in FIG. 6C represents voice sound energy received from a distance of four to eight meters, Figure D represents voice sound energy received from a distance of greater than eight meters, and FIG. 6E represents environmental noise which in this case is sound generated by a keyboard. Each of these spectrograms can represent and be assigned a different and unique sound type label.

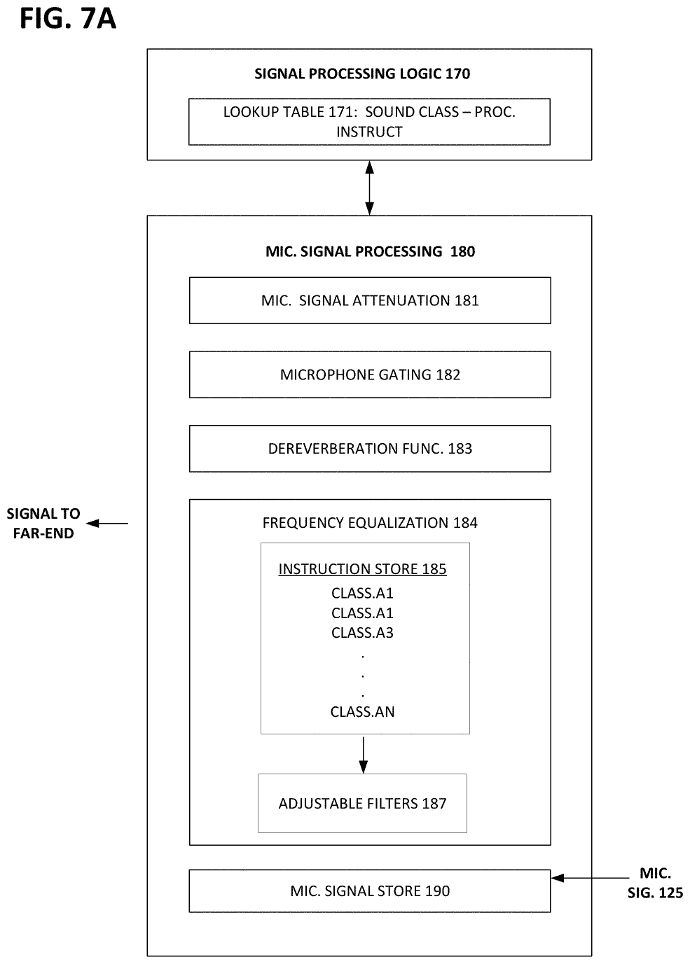

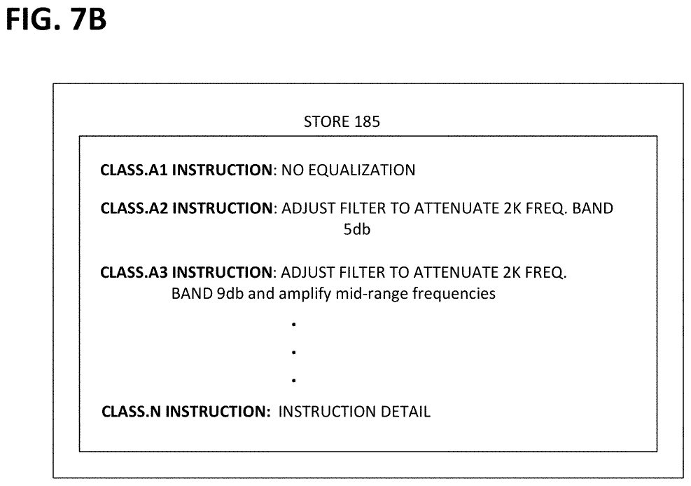

FIG. 7A is a diagram showing microphone signal processing functionality 180 comprising the conference system 110 described with reference to FIG. 2 and showing the logic 170 that operates to control which of the functions comprising the signal processing 180 are selected to operate on microphone signal information. The logic 170 is comprised of instructions stored in a non-volatile a computer readable medium associated with the system 110, and the logic has access to information in a lookup table that defines a relationship between classes of sound and particular signal processing functionality that is applied to a microphone signal corresponding to the class. This signal processing functionality includes, but is not limited to, microphone signal attenuation 181, gating 182, dereverberation 183, frequency equalization 184 and a store 190 of microphone signal information. The type of processing functionality that is selected by the logic 170 to be applied to a microphone signal (maintained in the store 190) depends upon the type of sound identified by the neural network. In this regard, the attenuation function can be selected if the neural network only identifies noise in the microphone signal, the gating function can be selected if far-field sound corresponding to voice activity is identified in the microphone signal, the dereverberation function can be selected with reverberation is detected, and frequency equalization can be selected if near-field sound corresponding to voice activity is identified. In operation, the system 110 may detect that a sample of sound is composed of both noise and near-field voice activity. In this case, the system has to determine which signal processing function to apply to the microphone signal to improve the signal quality. Depending upon how the neural network is trained, the system can operate to detect the degree to which both types of sound comprise the signal, and depending upon which type of sound is predominant, the appropriate processing function can be selected. So, if noise predominates over voice activity, then microphone gating can be selected, or if voice activity predominates over noise, then frequency equalization can be selected. Or if some far-field and near field voice activity is detected in the same sample, then signal attenuation can be selected and the microphone signal attenuated enough so that the far-field voice is less noticeable to a remote listener.

Depending upon the operating needs of the system 110, the signal attenuation functionality 181 comprising the signal processing 180 in FIG. 7A can be implemented as fixed attenuation or variable attenuation functionality. The implementational details of either arrangement are not discussed here as those skilled in the art of audio engineering understand how both are implemented. The microphone gating functionality operation and the dereverberation functionality 183 are also well understood by audio engineers and so will not be discussed here as well.

Continuing to refer to FIG. 7A, the frequency equalization function 184 is comprised of a store of signal equalization instructions 185 and adjustable filters 187. The store 185 has a plurality of filter control instructions each one of which is associated with a particular type or class of sound, such as the types of sound labeled Class.A1, Class.A2, and ClassA3 described earlier with reference to FIG. 4, and each one of these instructions can be selected by the logic 170 to control the operation of the adjustable filters to control the attenuation of certain frequencies in a microphone signal. According to one embodiment, the attenuated frequencies can comprise a band starting at the lowest frequency detectible by a microphone to approximately 2000 Hz or higher depending upon the capabilities of the microphone. one of the equalization instructions can be selected by the logic 170 to control the filters 187 to not attenuate, or to attenuate one of the lower frequencies comprising the microphone signal to a greater or lesser degree depending upon the distance from a sound source to the microphones as identified by the neural network 150. So for example, if the logic detects that the FFT identifies Class.A1 type of sound, than this class of sound can have instructions to not apply equalization to the microphone sign.

FIG. 7B illustrates each of the instructions comprising the store 185 in more detail. It should be understood that more or fewer instructions can be included in the store depending upon how the system 110 is intended to operate and how it is trained. As described earlier, Class.A1 corresponds to sound received by the system 110 from a distance that is equal to or greater than two feet and less than four feet. If it has been previously determined (i.e., empirically) that sound received by the system within this distance range does not need any equalization or processing of any kind, then the instruction corresponding to Class.A1 is selected and no signal processing is applied to the microphone signal.

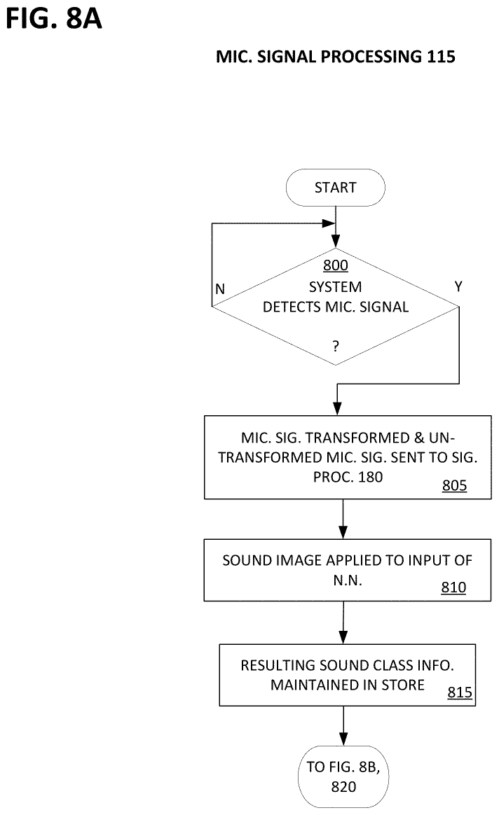

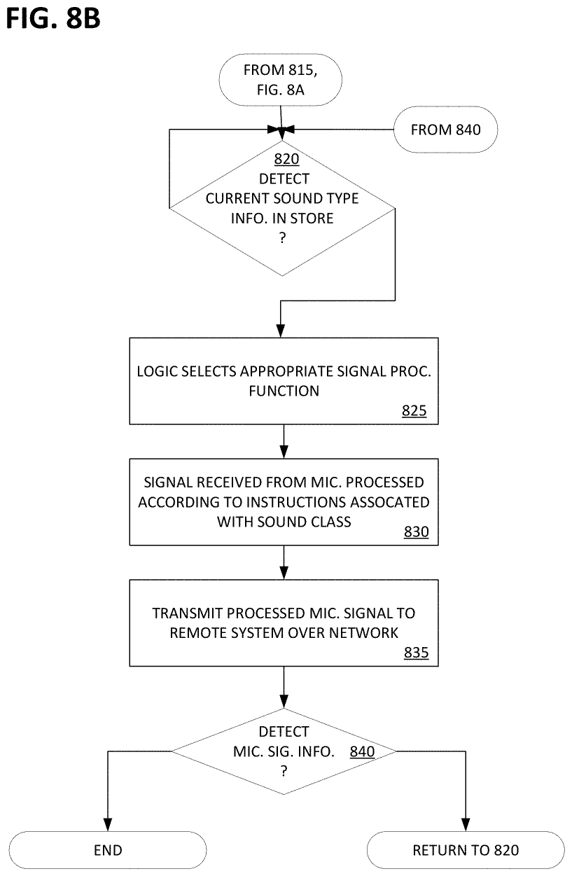

The operation of the system 110 to identify a type of sound and to process a microphone signal in accordance with the identified sound type will now be described with reference to FIG. 8A. It should be understood that the conference system 110 has previously been trained to detect different types of environmental sound and the system has been tested to validate the accuracy with which it is able to identify different types of sound. At the Start, the system 110 is controlled to be in a conference call, and therefore in the second mode of operation, and if at 800 it detects at least one sample of a microphone signal, then at 805 the microphone signal sample is transformed into a sound image by 130 and the microphone signal is also sent to the signal processing 180 and the logic 170 selects a function (based upon the current sound type) to apply to the microphone signal sample. For the purpose of this description we refer to a single microphone signal sample, but as previously described sound information received by system microphones is periodically samples during the period of time that the microphones are active. At 810 the system 110 operates to apply the sound image to the input of the trained neural network 150, and at 815 the output of the neural network, which is the identify of a sound type, is maintained in the store 160 as the current sound type and the process proceeds next to 820 in FIG. 8B.

Referring to FIG. 8B, if at 820 the system detects that there is current sound type information in the store 160, then the process proceeds to 825 and the logic 170 examines the current sound type information for a type label (i.e., Class.A1, Class.B, Class.C, etc.) and then uses this sound type label information as a pointer into the lookup table 171 to determine which processing function or functions can be applied to the microphone signal information maintained in the store 190. At 830 the logic causes the function to operate on the microphone signal maintained in the store 190, and at 835 the processed microphone signal is transmitted over a network to a remote communication system. Finally, if at 840 the system 110 detects another microphone signal then the process returns to 820, otherwise the process ends.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for identifying different types of sound, comprising:
recording a plurality of different types of sound and labelling each recording with a unique identifier corresponding to the sound type
transforming each sound recording into a plurality of training sound images, each training sound image being associated with the corresponding unique sound type identifier;
training a neural network to identify different types of sound by applying at least some of the plurality of the training sound images to the neural network;
receiving at a conference system sound generated by a source that is proximate to the conference system and transforming the sound into a plurality of sound images; and
applying the sound images to the trained neural network which operates on the sound images to identify at least one of the plurality of the different sound types.

2. The method of claim 1, further comprising the conference system operating on the sound received from the source with signal processing functionality corresponding to the identified at least one unique sound type.

3. The method of claim 2, wherein the signal processing functionality is comprised of microphone signal attenuation, microphone signal gating; dereverberation, and frequency equalization.

4. The method of 1, wherein each sound recording is periodically sampled, and the samples of sound are transformed into sound images.

5. The method of 4, wherein at least some of the periodic samples of sound overlap in time.

6. The method of claim 1, wherein the plurality of different types of sound comprise a near-field voice sound, a far-field voice sound, noise and silence.

7. The method of claim 6, wherein the near-field voice sound type comprises sound received by the conference system from sources that are located at difference distances or different distance ranges from the conference system, and each distance or distance range is assigned the unique sound type identifier.

8. The method of claim 1, wherein each sound image is a visual representation of one or more microphone signal sound characteristics.

9. The method of claim 1, wherein the conference system is an audio conference system or a video conference system.

10. The method of claim 6, wherein the noise is environmental sound received by the conference system at any distance, and silence is a low level of sound energy generated by the absence of voice sound or environmental sound.

11. A communication system for identifying a plurality of sound energy types, comprising:
a network communication device operating to receive and to transmit audio signal information, the communication device comprising a microphone signal processing function having:
functionality operating to transform microphone signals into sound images;
a store for maintaining the sound images;
a trained neural network operating on the stored sound images to identify different types of sound received by the system from the environment; and
a store to maintain a current sound type identified by the neural network.

12. The system of claim 11, further comprising signal processing logic, comprising instructions maintained in a non-transitory computer readable medium associated with the system, that operates to select any one or more of a plurality of signal processing techniques maintained by the system for processing microphone signals depending upon a current sound type detected by the neural network.

13. The communication system of claim 11 comprising an audio conference system or a video conference system.

14. The system of claim 11, further comprising functionality that operates to periodically sample the microphone signal.

15. The system of claim 14, wherein the microphone signal samples are operated on by functionality that transforms them into images of sound information.

16. The system of claim 15, wherein at least some of the periodic samples of sound overlap in time.

17. The method of claim 11, wherein the plurality of different types of sound comprise a near-field voice sound, a far-field voice sound, noise and silence.

18. The method of claim 17, wherein the near-field voice sound type comprises sound received by the conference system from sources that are located at difference distances or different distance ranges from the conference system, and each distance or distance range is assigned the unique sound type identifier.

19. The method of claim 17, wherein the noise is environmental sound received by the conference system at any distance, and silence is a low level of sound energy generated by the absence of voice sound or environmental sound.
